(19) United States
(12) Patent Application Publication
(10) Pub. No.: US 2019/0277355 A1
(43) Pub. Date: Sep. 12, 2019

(54) DRAG REDUCING STRUCTURE AND ELECTRIC DISK BRAKE HAVING THE SAME

(71) Applicant: MANDO CORPORATION, Gyeonggi-do (KR)

(72) Inventor: Kyungwon KIM, Gyeonggi-do (KR)

(21) Appl. No.: 16/292,275

(22) Filed: Mar. 4, 2019

(30) Foreign Application Priority Data
Mar. 12, 2018 (KR) 10-2018-0028906

(51) Int. Cl. F16D 65/18; B60T 1/06; F16D 55/226

(52) U.S. Cl. CPC F16D 65/18; F16D 2121/04; F16D 55/226; B60T 1/065

(57) ABSTRACT

The present disclosure relates to a drag reducing structure. The drag reducing structure according to an embodiment of the present disclosure includes: a piston configured to press or release a friction pad pressing at least one side of a disk; a spindle unit configured to move in frontward and backward directions in the piston to press or release the piston; and at least one stopper formed at one side of the piston to come into contact with one side of the spindle unit and move the piston in a backward direction when the spindle unit moves in the backward direction to move the piston when a braking force is released and reduce the drag phenomenon which occurs due to a restoration defect of the piston.

### CROSS-REFERENCE TO RELATED APPLICATION

This application claims priority to and the benefit of Korean Patent Application No. 2018-0028906, filed on Mar. 12, 2018, the disclosure of which is incorporated herein by reference in its entirety.

### BACKGROUND

### 1. Field of the Invention

The present disclosure relates to a drag reducing structure and an electric disk brake having the same.

### 2. Discussion of Related Art

Generally, a brake is an apparatus configured to stop a vehicle during braking or parking so that the vehicle cannot move and serves to hold wheels of the vehicle to prevent rotation of the wheels. Recently, an electric parking brake (EPB) system configured to electronically control driving of a parking brake is widely used and mounted on a general disk brake that generates a braking force by strongly pressing a part of a disk rotating together with a wheel using friction pads from both sides to serve as the parking brake.

In this case, an electric parking brake includes a cable puller type, a motor-on-caliper type, and a hydraulic parking brake type. A conventional caliper-type electric parking brake forms a braking force by a friction force between the disk and the friction pads when the braking force is generated. The friction force is generated by the friction pads configured to come into contact with the disk due to a hydraulic pressure formed when a brake pedal is operated by a driver, and since brake pads and the disk are separated through a knock back phenomenon between the friction pads and the disk and a roll back phenomenon of a caliper piston seal, the friction force is removed.

However, since restoration of the conventional caliper-type electric parking brake piston only depends on an elastic restoring force of the piston seal, and thus a drag phenomenon in which the friction pads and the disk are not completely separated frequently occurs, a lifespan of each of the friction pads can reduce and output can be lowered due to unnecessary friction.

Further, since the drag phenomenon is involved in shape deformation and restoration of the piston seal, the restoration is small when the deformation of the piston seal is small, and accordingly, the drag phenomenon frequently occurs and can cause fuel efficiency loss.

### SUMMARY OF THE INVENTION

The present disclosure is directed to providing a drag reducing structure capable of reducing a drag phenomenon due to abnormal contact between a disk and friction pads when braking is released so as to contribute to fuel efficiency improvement and satisfy strengthened environmental regulations, and an electric disk brake including the same.

According to an aspect of the present disclosure, there is provided a drag reducing structure including: a piston configured to press or release a friction pad pressing at least one side of a disk; a spindle unit configured to move in frontward and backward directions in the piston to press or release the piston; and at least one stopper formed at one side of the piston to come into contact with a part of the spindle unit and move the piston in a backward direction when the spindle unit moves in the backward direction in order to move the piston when a braking force is released and reduce the drag phenomenon which occurs due to a restoration defect of the piston.

In this case, the spindle unit may include a nut member configured to move in frontward and backward directions in the piston and a spindle member coupled to the nut member to rotate so that the nut member moves, and the stopper may come into contact with one side of the nut member to move the piston when the nut member moves in the backward direction.

The nut member may include a pressing part configured to come into contact with the piston to press the piston and a body part formed to extend from the pressing part and screw-coupled to the spindle member.

The pressing part may be formed to extend outward from the body part and may come into contact with the stopper when the nut member moves in the backward direction.

The stopper may be disposed to be spaced apart from the pressing part by a predetermined distance when the pressing part presses the piston to come into contact with the piston, and the predetermined distance may be a hydraulic distance in which the piston is movable in a frontward direction by a hydraulic pressure.

The stopper may be formed to protrude from an inner side surface of the piston.

A distance from a center of the body part to one side end portion of the pressing part in an outward direction may be greater than a distance from the center of the body part to the stopper.

The drag reducing structure may further include a cylinder in which the piston is installed to be movable in frontward and backward directions and a piston seal installed between an outer side surface of the piston and an inner side surface of the cylinder.

According to another aspect of the present disclosure, there is provided an electric disk brake including: a caliper housing in which friction pads configured to surround a disk rotating with a wheel to rub with the disk are installed to be movable and a cylinder is provided therein; and a drag reducing structure including a piston installed in the cylinder to be movable in frontward and backward directions to press the friction pads toward the disk or release the friction pads, a spindle unit including a spindle member rotatably installed in the caliper housing and a nut member configured to move in frontward and backward directions according to rotation of the spindle member, and a stopper formed at one side of the piston to come into contact with one side of the spindle unit and move the piston in a backward direction when the spindle unit moves in the backward direction.

The electric disk brake may further include an electronic control unit configured to advance the nut member of the spindle unit and control so that a predetermined distance between the stopper and the nut member is secured when the piston moves in the backward direction and a pressure to the friction pads is released.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a cross-sectional view illustrating a drag reducing structure according to an embodiment of the present disclosure and an electric disk brake including the same;

FIG. 2 is a cross-sectional view illustrating the drag reducing structure according to the embodiment of the present disclosure;

FIG. 3 is a side view illustrating a spindle unit of the drag reducing structure according to the embodiment of the present disclosure;

FIG. 4 is a cross-sectional view illustrating an operation state of the drag reducing structure according to the embodiment of the present disclosure;

FIG. 5 is a graph illustrating electronic control currents of a conventional electric disk brake; and

FIG. 6 is a graph illustrating electronic control currents of an electric disk brake according to the embodiment of the present disclosure.

### DETAILED DESCRIPTION OF EXEMPLARY EMBODIMENTS

Hereinafter, exemplary embodiments of the present disclosure will be described in detail with reference to the accompanying drawings which may allow one of ordinary skill in the art to easily perform the present disclosure. The present disclosure may be implemented in various forms and is not limited to the following embodiments. Components not related to the description are omitted in the drawings to clearly describe the present disclosure, and the same reference symbols are used for the same or similar components in the description.

It should be further understood that the terms “include,” “including,” “provide,” “providing,” “have,” and/or “having” specify the presence of stated features, integers, steps, operations, elements, components, and/or groups thereof, but do not preclude the presence or addition of one or more other features, integers, steps, operations, elements, components, and/or groups thereof.

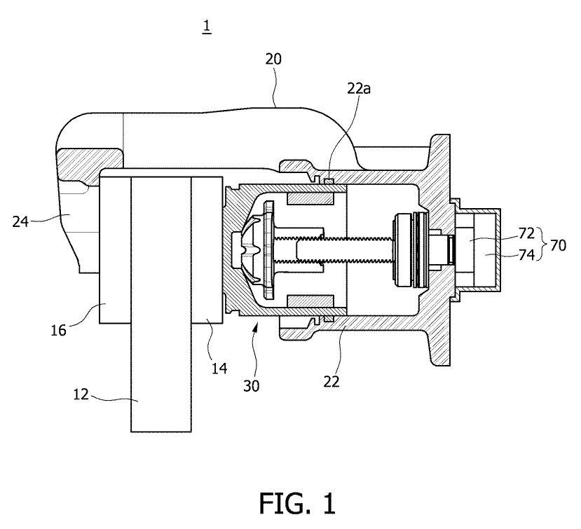

FIG. 1 is a cross-sectional view illustrating a drag reducing structure according to an embodiment of the present disclosure and an electric disk brake including the same.

In the following description, on the basis of FIG. 1, a direction from a drag reducing structure 30 to a disk 12 is defined and described as a frontward direction, and a direction from the disk 12 to the drag reducing structure 30 is defined and described as a backward direction.

An electric disk brake 1 according to the embodiment of the present disclosure includes a caliper housing 20, the drag reducing structure 30, and an actuator 70. Accordingly, the electric disk brake 1 according to the embodiment of the present disclosure may include the drag reducing structure 30 and reduce a drag phenomenon due to abnormal contact between the disk 12 and friction pads 14 and 16 when braking is released to contribute to fuel efficiency improvement and satisfy a strengthened environmental regulation.

Meanwhile, in the embodiment of the present disclosure, a carrier (not shown) may be coupled to a vehicle body, and the disk 12 and the pair of friction pads 14 and 16 may be installed in the carrier. In this case, the disk 12 may be installed to rotate together with a wheel, and the pair of friction pads 14 and 16 may be installed to advance and retreat to rub with the disk.

The pair of friction pads 14 and 16 may be installed to be spaced apart from each other. Further, the disk 12 is disposed between the pair of friction pads 14 and 16 and the pair of friction pads advance to and retreat from both side surfaces of the disk 12 to perform braking.

Referring to FIG. 1, in the embodiment of the present disclosure, the pair of friction pads 14 and 16 may include a first friction pad 14 disposed to come into contact with a piston 32 which will be described below and a second friction pad 16 disposed to come into contact with a finger part 24 of the caliper housing 20 which will be described below. In this case, the first friction pad 14 may be installed behind the disk 12 to press a back surface of the disk and the second friction pad 16 may be installed in front of the disk 12 to press a front surface of the disk.

Meanwhile, the caliper housing 20 may be coupled to the carrier to be slidable and may include a cylinder 22 and the finger part 24. In this case, the cylinder 22 may be installed behind the first friction pad 14 and the piston 32 may be installed in the cylinder 22 to advance and retreat.

In the embodiment of the present disclosure, the finger part 24 may be formed to be bent in a downward direction and may be installed in front of the second friction pad 16 so that an inner side surface of the finger part may come into contact with a front surface of the second friction pad. In this case, in the embodiment of the present disclosure, the finger part 24 and the cylinder 22 may be integrally formed.

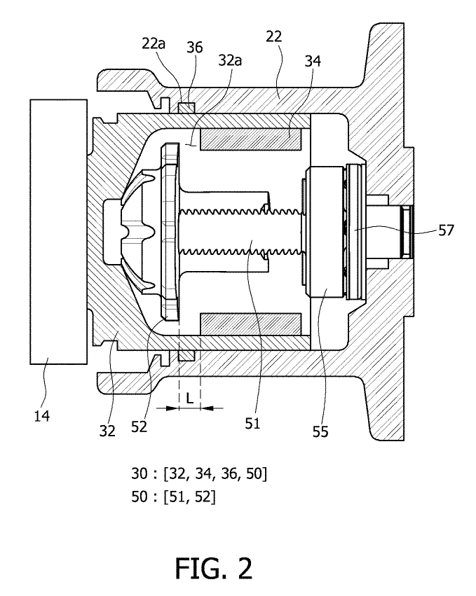

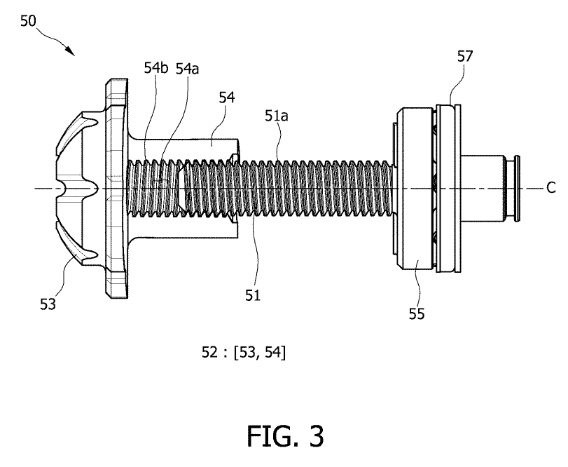

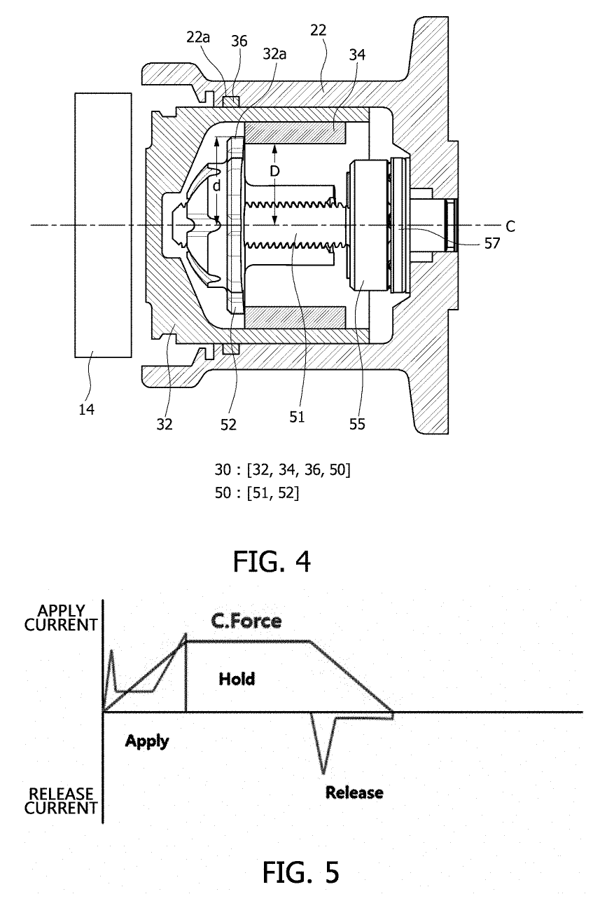

FIG. 2 is a cross-sectional view illustrating the drag reducing structure according to the embodiment of the present disclosure, FIG. 3 is a side view illustrating a spindle unit of the drag reducing structure according to the embodiment of the present disclosure, and FIG. 4 is a cross-sectional view illustrating an operation state of the drag reducing structure according to the embodiment of the present disclosure.

Referring to FIGS. 2 and 3, in the embodiment of the present disclosure, the drag reducing structure 30 may include a spindle unit 50, the piston 32, a stopper 34, and a piston seal 36. Accordingly, the drag reducing structure 30 according to the embodiment of the present disclosure may release the abnormal contact between the disk and the friction pads by pulling the piston in a backward direction when a drag phenomenon occurs according to the abnormal contact between the disk 12 and the friction pads 14 and 16 due to a restoration defect of the piston 32 in the case in which the braking is released.

In the embodiment of the present disclosure, the piston 32 has a circular cross-sectional surface and the spindle unit 50 may be inserted into the piston to be slidable therein. In this case, the piston 32 may have a moving groove 32a formed in one side thereof, for example, a back surface, so that the spindle unit 50 may move on the back surface of the piston. Further, the piston 32 may be inserted into the cylinder 22 to be slidable.

In this case, the piston 32 may press the first friction pad 14 in a frontward direction, for example, as shown in FIG. 1, toward the disk 12 due to an axial force of the spindle unit 50 configured to receive a rotating force of the actuator 70.

Further, in the embodiment of the present disclosure, when a hydraulic pressure for braking is applied into the cylinder 22, the piston 32 may advance toward the first friction pad 14 by a hydraulic distance L to press the first friction pad 14, and since the caliper housing 20 operates in a direction opposite to that of the piston 32 due to a reacting force, the finger part 24 presses the second friction pad 16 in a backward direction, for example, a direction toward the disk 12, to perform the braking.

Referring to FIG. 2, in the embodiment of the present disclosure, the piston seal 36 may be installed between an outer circumferential surface of the piston 32 and an inner circumferential surface of the cylinder 22. In this case, the piston seal 36 may be fitted into a mounting groove 22a formed in the inner circumferential surface of the cylinder 22 to come into contact with the outer circumferential surface of the piston 32. In this case, the piston seal 36 may provide an elastic restoring force in which the piston seal 36 is elastically transformed by the piston 32 when the braking is performed and then the piston returns to an original position when the braking is released.

Meanwhile, in the embodiment of the present disclosure, the stopper 34, which is configured to come into contact with the spindle unit when the spindle unit 50 moves in a backward direction to move the piston 32 in the backward direction when the braking is released, may be installed in the piston 32. In this case, the stopper 34 may be formed to protrude inward from an inner circumferential surface of the piston 32.

Further, in the embodiment of the present disclosure, the stopper 34 may be formed to extend along a circumferential direction of the piston 32. In this case, the stopper 34 may be formed to extend in an extending direction, and the stopper 34 and the nut member 52 may be disposed to be spaced apart from each other by a predetermined distance L. In this case, the predetermined distance L may be a hydraulic distance in which the piston 32 moves when the hydraulic pressure for braking is applied to the inside of the cylinder 22.

Meanwhile, referring to FIG. 3, in the embodiment of the present disclosure, the spindle unit 50 may receive the rotating force from the actuator 70, which includes a motor 74 and a decelerator 72, to press the piston 32 toward the first friction pad 14. In this case, the spindle unit 50 may include a nut member 52, a spindle member 51, and a bearing 57.

Meanwhile, in the embodiment of the present disclosure, the spindle member 51 may be formed in a cylindrical shape. In this case, one side of the spindle member 51, as shown in FIG. 1, for example, a rear side of the spindle member, may be rotatably installed through the caliper housing 2, that is, the cylinder 22, and the other side, for example, a front side of the spindle member, may be disposed in the piston 32.

Further, a rear end portion of the spindle member 51 configured to pass through the cylinder 22 may be connected to the decelerator 72 and receive a rotating force of the motor 74. In this case, a male screw thread 51a may be formed on an outer circumferential surface of a front end portion of the spindle member 51 and screw-coupled to the nut member 52.

Referring to FIG. 3, in the embodiment of the present disclosure, a flange part 55 may be formed behind the spindle member 51. In this case, the flange part 55 may have a ring-shaped cross-sectional surface and the spindle member 51 may be insertion-fixed to a center of the flange part 55.

Meanwhile, in the embodiment of the present disclosure, the nut member 52 may include a pressing part 53 and a body part 54. In this case, referring to FIG. 4, a front side of the pressing part 53 may be formed to come into contact with the piston 32 and press the piston. Further, a front surface of the pressing part 53 may be formed in an arc shape and the pressing part 53 may be formed as a semicircular cross-sectional surface.

In this case, the pressing part 53 may be formed on a front end portion of the body part 54 and formed to extend outward from the body part. Accordingly, in the embodiment of the present disclosure, when the nut member 52 moves in a backward direction in the case in which the breaking force is released, one side of the pressing part 53, for example, a side end portion of the pressing part, may come into contact with the stopper 34 formed on the inner side surface of the piston 32 to move the piston in the backward direction when the nut member 52 moves by the hydraulic distance L.

Meanwhile, the body part 54 may be formed to extend from the pressing part 53 in a backward direction. Further, the body part 54 may be formed in a cylindrical shape to surround the spindle member so that the spindle member 51 may be inserted and screw coupled thereinto. In this case, in the embodiment of the present disclosure, the pressing part may be integrally formed with the body part 54.

In the embodiment of the present disclosure, the body part 54 may have a through hole 54a formed to extend along a longitudinal direction of the nut member in a center so that the spindle member 51 may be inserted and screw-coupled thereto.

In this case, the body part 54 may have a U shape, the through hole 54a may be formed to correspond to an outer side surface of the spindle member 51 so that the spindle member 51 may be inserted thereinto, and a female screw thread 54b may be formed on an inner side surface of the through hole to be screw-coupled to the male screw thread 51a of the spindle member 51.

In the embodiment of the present disclosure, the nut member 52 may be screw-coupled to the spindle member 51 to advance and retreat in frontward and backward directions or an axial direction according to a rotating direction of the spindle member, and accordingly, the nut member may come into contact with the piston 32 to press the piston and, on the other hand, may be spaced apart from the close piston to release a pressure to the piston.

Further, in the embodiment of the present disclosure, the nut member 52 may be coupled to a front side of the spindle member 51 and may be coaxially formed with a center axis c of the spindle member 51. In this case, the center axis c of the spindle member 51 may be a center of the body part 54.

In this case, a distance d from the center c of the body part 54 to one side end portion of the pressing part 53 in an outwardly radial direction may be greater than a distance D from the center of the body part 54 to the stopper 34. Accordingly, when the nut member 52 moves in the backward direction in the case in which a braking force is released, the one side end portion of the pressing part 53 may come into contact with the stopper 34 formed on the inner side surface of the piston 32 when the nut member 52 moves by the hydraulic distance L to move the piston in the backward direction.

In the embodiment of the present disclosure, the bearing 57 may be installed behind the flange part 55 to support the spindle member 51. In this case, the bearing 57 may be inserted into the spindle member 51 and installed between the spindle member and the inner side surface of the cylinder 22. In the embodiment of the present disclosure, the bearing 57 may be a needle bearing or a thrust bearing but is not limited thereto. In this case, the bearing 57 may reduce a friction force between the spindle member and the inner side surface of the cylinder 22 to efficiently prevent abrasion of components when the spindle member 51 rotates.

In the embodiment of the present disclosure, the bearing 57 may be coupled to the rear side of the spindle member 51, and the nut member 52 may be coupled to the front side of the spindle member 51. In this case, the bearing 57 and the nut member 52 may be coaxially formed with the center axis c of the spindle member 51.

The drag reducing structure 30 according to the embodiment of the present disclosure may prevent the abnormal contact between the disk and the friction pads by including a stopper 34 and pulling the piston in a backward direction when the drag phenomenon occurs due to the abnormal contact between the disk and the friction pads according to the restoration defect of the piston in the case in which the braking is released.

Further, the electric disk brake 1 according to the embodiment of the present disclosure may prevent not only the abrasion generated by the abnormal contact between the disk and the friction pads but also an occurrence of noises and vibrations by including the drag reducing structure 30 to reduce the drag phenomenon.

Meanwhile, the electric disk brake 1 according to the embodiment of the present disclosure may further include an electronic control unit (not shown), and the electronic control unit may advance the nut member 52 of the spindle unit 50 and control so that a predetermined distance between the stopper 34 and the nut member 52 may be secured when the piston 32 moves in the backward direction and the pressure to the friction pads 14 and 16 is released.

A graph illustrating a graph illustrating electronic control currents of a conventional electric disk brake is shown in FIG. 5, and in the graph, the currents necessary for an advance of a spindle unit are applied according to control of an electronic control unit when advancing a piston to press friction pads is necessary, and currents for backing the spindle unit are released according to the control of the electronic control unit when releasing of a braking state is necessary.

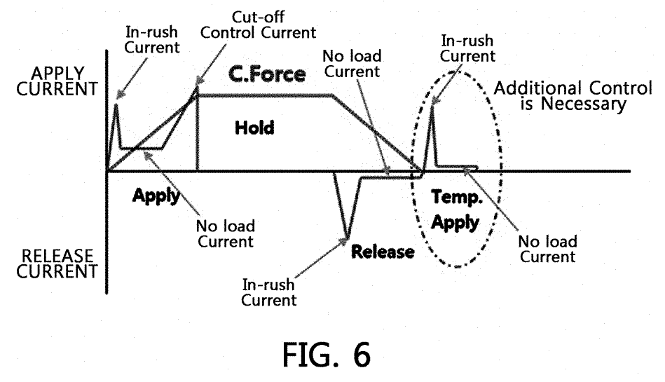

However, in the present disclosure, when the nut member 52 of the spindle unit 50 comes into close contact with the stopper 34 in the braking state, since the hydraulic distance L shown in FIG. 2 is difficult to secure due to interference between the nut member 52 and the stopper 34 when later braking is performed, currents (Temp. Apply) according to additional control as shown in FIG. 6 are necessary. That is, since the electronic control unit controls so that the currents are additionally applied as shown in FIG. 6 when the piston 32 moves in the backward direction and the pressure to the friction pads 14 and 16 is released, the nut member 52 of the spindle unit 50 is advanced so that the predetermined distance between the stopper 34 and the nut member 52 is secured. Accordingly, the hydraulic pressure may be sufficiently applied to the nut member 52 when later braking is performed. In this case, the predetermined distance may be the hydraulic distance L.

A drag reducing structure according to an embodiment of the present disclosure and an electric disk brake including the same can prevent abnormal contact between a disk and friction pads by including a stopper and pulling a piston in a backward direction when a drag phenomenon occurs according to the abnormal contact between the disk and the friction pads due to a restoration defect of the piston in the case in which braking is released.

Further, the drag reducing structure according to the embodiment of the present disclosure and the electric disk brake including the same can prevent not only abrasion generated by the abnormal contact between the disk and the friction pads but also an occurrence of noises and vibrations by including the stopper so as to reduce the drag phenomenon.

Although one embodiment of the present disclosure is described above, the spirit of the present disclosure is not limited to the embodiment shown in the description, and although those skilled in the art may provide other embodiments due to addition, change, or removal of the components within the scope of the same spirit of the present disclosure, the above embodiments are also included in the scope of the spirit of the present disclosure.

What is claimed is:

1. A drag reducing structure configured to move a piston when a braking force is released and reduce a drag phenomenon which occurs due to a restoration defect of the piston, the drag reducing structure comprising:
a piston configured to press or release a friction pad pressing at least one side of a disk;
a spindle unit configured to move in frontward and backward directions in the piston to press or release the piston; and
at least one stopper formed at one side of the piston to come into contact with a part of the spindle unit and move the piston in a backward direction when the spindle unit moves in the backward direction.

2. The drag reducing structure of claim 1, wherein:
the spindle unit includes a nut member configured to move in frontward and backward directions in the piston and a spindle member coupled to the nut member to rotate so that the nut member moves; and
the stopper comes into contact with one side of the nut member to move the piston when the nut member moves in the backward direction.

3. The drag reducing structure of claim 2, wherein the nut member includes a pressing part configured to come into contact with the piston to press the piston and a body part formed to extend from the pressing part and screw-coupled to the spindle member.

4. The drag reducing structure of claim 3, wherein the pressing part is formed to extend outward from the body part and comes into contact with the stopper when the nut member moves in the backward direction.

5. The drag reducing structure of claim 3, wherein:
the stopper is disposed to be spaced apart from the pressing part by a predetermined distance when the pressing part presses the piston to come into contact with the piston; and
the predetermined distance is a hydraulic distance in which the piston is movable in a frontward direction by a hydraulic pressure.

6. The drag reducing structure of claim 1, wherein the stopper is formed to protrude from an inner side surface of the piston.

7. The drag reducing structure of claim 6, wherein a distance from a center of the body part to one side end portion of the pressing part in an outward direction is greater than a distance from the center of the body part to the stopper.

8. The drag reducing structure of claim 1, further comprising: a cylinder, in which the piston is installed to be movable in frontward and backward directions; and
a piston seal installed between an outer side surface of the piston and an inner side surface of the cylinder.

9. An electric disk brake comprising:
a caliper housing in which friction pads configured to surround a disk rotating with a wheel to rub with the disk are installed to be movable and a cylinder is provided therein; and
a drag reducing structure including a piston installed in the cylinder to be movable in frontward and backward directions to press the friction pads toward the disk or release the friction pads, a spindle unit including a spindle member rotatably installed in the caliper housing and a nut member configured to move in frontward and backward directions according to rotation of the spindle member, and a stopper formed at one side of the piston to come into contact with one side of the spindle unit and move the piston in a backward direction when the spindle unit moves in the backward direction.

10. The electric disk brake of claim 9, further comprising an electronic control unit configured to advance the nut member of the spindle unit and control so that a predetermined distance between the stopper and the nut member is secured when the piston moves in the backward direction and a pressure to the friction pads is released.
